(19) United States
(12) Patent Application Publication
(10) Pub. No.: US 2005/0288800 A1
(43) Pub. Date: Dec. 29, 2005

(54) Accelerating computational algorithms using reconfigurable computing technologies

(76) Inventors: William David Smith, Schenectady, NY (US); Daniel Lawrence Morrill, Scotia, NY (US); Austars Raymond Schnore JR., Scotia, NY (US); Mark Richard Gilder, Clifton Park, NY (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/878,979

(22) Filed: Jun. 28, 2004

(51) Int. Cl. G05B 13/02

(52) U.S. Cl. 700/28; 700/37; 700/46

(57) ABSTRACT

A system for accelerating computational fluid dynamics calculations with a computer, the system including a plurality of reconfigurable hardware components; a computer operating system with an application programming interface to connect to the reconfigurable hardware components; and a peripheral component interface unit connected to the reconfigurable hardware components for configuring and controlling the reconfigurable hardware components and managing communications between each of the plurality of reconfigurable hardware components to bypass the peripheral component interface unit and provide direct communication between each of the plurality of configurable hardware components.

### BACKGROUND OF THE INVENTION

This invention relates to computational techniques and, more specifically, to a system and method for accelerating the calculation of computational fluid dynamics algorithms. Computational fluid dynamics (CFD) simulations are implemented in applications used by engineers designing and optimizing complex high-performance mechanical and/or electromechanical systems, such as jet engines and gas turbines.

Currently, CFD algorithms are run on a variety of high-performance general-purpose systems, such as clusters of many independent computer systems in a configuration known as Massively Parallel Processing (MPP) configuration; servers and workstations consisting of many processors in a “box” configuration known as a Symmetric Multi-Processing (SMP) configuration; and servers and workstations incorporating a single processor (uniprocessor) configuration. Each of these configurations may use processors or combinations of processors from a variety of manufacturers and architectures. General-purpose processor families in common use in each of these configurations (MPP, SMP, and uniprocessor) include but are not limited to Intel Pentium Xeon; AMD Opteron; and IBM/Motorola PowerPC.

An algorithm implemented on a given general-purpose processor computer configuration will, in practice, only be able to sustain a percentage of its theoretically maximum (peak) performance. Algorithm implementations that attain a relatively high sustained performance rate (compared to other implementations) are judged by those skilled in the art to be higher quality implementations than others that have a lower sustained performance. Performance is typically measured in units such as, but not limited to, “floating point operations per second” (FLOPS), processor cycles per second, etc.

Input data for a CFD simulation is stored in computer memory, and as the algorithm runs it reads data out of this memory into a smaller, extremely high-speed memory cache located on a processor die. To the extent that the processor can operate using data exclusively from its cache, it will attain a high sustained performance. Hardware known as a “cache manager” associated with the processor attempts to anticipate the algorithm to ensure that the data required by the processor is always located in the fast memory cache.

Substantially all known general-purpose processors operate on the so-called Principle of Locality, which assumes that if data is accessed at a particular point in memory, then the data fields very near to the data just accessed are also very likely (but not guaranteed) to be used in the near future. General-purpose processor cache managers attempt to keep the processor cache populated according to this principle; it is not 100% effective, but is rather a reasonable “best guess.”

A “cache miss” or “page fault” is said to occur when the cache manager fails to predict the processor's needs, and must copy some data from main memory into fast cache memory. If an algorithm causes a processor to have frequent cache misses, the performance of that implementation of the algorithm will be decreased, often dramatically. Thus, having a high-quality cache management algorithm is important to attaining high sustained performance.

CFD applications, as simulations of real-world physics, involve calculations over data in three dimensions. Typically, the data represents a “mesh” of points that models a component to be analyzed with the CFD application. This memory and data organization means that CFD algorithms must use a strided pattern when accessing data (meaning that the processor “strides” over data in memory, skipping one or many data fields, rather than accessing each data field strictly sequentially.) The cache managers for general-purpose processors, however, are typically optimized to assume that algorithms running on the processor are going to use highly localized, sequential access (i.e. follow the Principle of Locality). As a result, general-purpose processors essentially attempt to cache main memory data in precisely the wrong manner for CFD calculations, resulting in a large number of cache misses, and ultimately in low sustained performance.

A second cache-related performance constraint for CFD algorithms is the cache expiration policy. Since processors' caches are much smaller in capacity than system main memory, the cache manager must pick and choose which data to retain copies of, and which data to “expire” (remove) from the cache as no longer relevant. Typically, general-purpose cache managers use a Least-Recently Used (LRU) algorithm, which simply expires data in order of how many cycles have elapsed since the data was last used. For CFD algorithms, the LRU policy may result in data cache problems where array values at the start of a data vector scan are dropped from the cache when it is time to start the next vector scan.

Another performance issue impacting CFD algorithms is the communications bandwidth between the processor and the main memory. Despite the strided access pattern, all input data will eventually be used, and must move from main memory to the processor. Similarly, the computed results must be moved back to the main memory, again using a strided access pattern. Since the processor typically runs at a clock rate much higher than the rate at which data can be transferred from main memory, the processor is frequently idle waiting for data to transfer to or from main memory. The above explanations are exemplary reasons why CFD applications using a general-purpose processor do not typically achieve high sustained performance.

In practice, engineers run CFD algorithms on very large sets of data—so large that they cannot possibly all fit into any realistic amount of a computer's main memory. Instead, this data will be stored on large-capacity secondary storage devices (such as disk drives) and processed in pieces. Toward this end, larger CFD analyses must be decomposed into smaller regions that will fit in available processor memory. Breaking up a larger mesh into a set of smaller three-dimensional meshes will allow these smaller meshes to be computed independently by a number of processors working in parallel. Allowing processors to work in parallel introduces synchronization issues involving the propagation of boundary conditions among the smaller mesh regions, wherein diminishing returns are realized as the number of parallel processors increases. This ultimately becomes a limit to the extent to which CFD algorithms can be accelerated through the use of parallel processing on traditional processors.

### BRIEF DESCRIPTION OF THE INVENTION

The present invention provides for a system and method that overcomes the limitations associated with cache and memory bandwidth discussed above, improving on the general-purpose processor method of computing CFD algorithms. For example, in one exemplary embodiment, a system for accelerating computational fluid dynamics calculations with a computer system is disclosed. The system has a plurality of reconfigurable hardware components, a floating-point library connected to the reconfigurable hardware components, a computer operating system with an application programming interface to connect to the reconfigurable hardware components, and a peripheral component interface unit connected to the reconfigurable hardware components. The peripheral component interface unit configures and controls the reconfigurable hardware components and manages communications whereby communications between the plurality of reconfigurable hardware components bypass the peripheral component interface unit and communications occur directly between each of the plurality of configurable hardware components.

In another exemplary embodiment, a reconfigurable computing system for computing computational fluid dynamics algorithms is disclosed. This system includes a first data stream and a first memory controller that can send and/or receive the first data stream. A first data cache is connected to the first memory controller and a data path pipeline is connected to the data cache. The data path pipeline generates a data signal. A first address generator is connected to the data path pipeline and the data cache, and a second data cache is connected to the data path pipeline. A second address generator is connected to the data path pipeline and the second data cache. A second memory controller is connected to the address generator and the data cache, and a second data stream is sent from and/or to the second memory controller. The first data stream is fed through the first memory controller, the first data cache, the data path pipeline, the second data cache, and the second memory controller wherein the second data stream is produced. The data signal is created and/or fed through the data path pipeline, the first address generator, the data cache, the first memory controller, the second address generator, the second data cache, and the second memory controller.

A method for accelerating computing computational fluid dynamics algorithms where a stencil is swept through a three-dimensional array is further disclosed. The method includes transmitting data to and from a first memory device. An address generator is used to manage the transmitting of the data. The stencil is swept through a three dimensional array. Inner-loop calculations are performed during the stencil sweep. Resulting data generated from the inner-loop calculations is transmitted to a first array cache. The resulting data is transmitted from the first data cache to a second memory device.

### BRIEF DESCRIPTION OF THE DRAWINGS

The invention will be better understood when consideration is given to the following detailed description taken in conjunction with the accompanying drawings in which:

FIG. 1 is a block diagram of an exemplary computational fluid dynamic accelerator;

FIG. 2 is a block diagram of an exemplary computational fluid dynamic processing node architecture;

FIG. 3 is a block diagram of an exemplary communication architecture for a PCI carrier card;

FIG. 4a is a block diagram of an exemplary module that is connected to the PCI carrier card of FIG. 3;

FIG. 4b is a block diagram of a second exemplary module in an alternate configuration that is connected to the PCI carrier card of FIG. 3;

FIG. 5 is a block diagram of exemplary functional components in a reconfigurable computing accelerator embodying aspects of the invention;

FIG. 6 is a block diagram illustrating exemplary synchronization between execution threads;

FIG. 7 is a block diagram illustrating an exemplary pipeline synchronization mechanism embodying aspects of the invention;

FIG. 8a is an illustration of an exemplary processing scan during an array scan;

FIG. 8b is an illustration of an exemplary concurrent processing waves during an array scan;

FIG. 9 is a block diagram of exemplary functional components in a reconfigurable computing accelerator capable of implementing concurrent processing waves;

FIG. 10 is a block diagram illustrating concurrent processing waves; and

FIG. 11 is an exemplary embodiment of a block diagram illustrating concurrent processing waves.

### DETAILED DESCRIPTION OF THE INVENTION

The system and method steps of the present invention have been represented by conventional elements in the drawings, showing only those specific details that are pertinent to the present invention, so as not to obscure the disclosure with structural details that will be readily apparent to those skilled in the art having the benefit of the description herein. Additionally, the phraseology and terminology employed herein are for the purpose of description and should not be regarded as limiting. Furthermore, even though this disclosure refers primarily to computational fluid dynamic algorithms, the present invention is applicable to other advanced algorithms that require a significant amount of computing.

In order to understand the improvements offered by the present invention, it is useful to understand some of the principles used with computational fluid dynamics (CFD). Though there is a plurality of CFD algorithms, a general algorithm structure for CFD algorithms discussed herein for purposes of illustration, and not to limit the invention, is based on Reynolds Averaged Navier-Stokes methods. These algorithms iterate over a mesh in a three-dimensional volume, representing a CFD system, in order to compute the physical properties of each point within the volume. The value for the next state of a mesh point is computed based on the values of the current mesh points and its immediate neighbors.

A typical three-dimensional mesh size, which is on the order of 100×100×100 (or 10⁶) mesh points and requires on the order of 10,000 iterations, is required for the CFD analysis to converge to a result. In view of this, the inner loop, or kernel, calculations are invoked on the order of 10¹⁰ times. Specifics of the calculations used in the inner loop typically will vary, based upon the function. A single inner loop iteration may require several hundred floating-point operations. Thus, a total number of floating point calculations required for each function can be more than a Trillion Floating Point Operations Per Second (TeraFLOP or TFLOP).

A key performance factor of CFD algorithms is the memory access patterns used in computing a mesh point's value. The access patterns are referred to as stencils. The dimensions of the access pattern define the stencil geometry and have implications on the performance of the CFD algorithm implementation. For example, the CFD calculation for a single array scan proceeds by sweeping the algorithm stencil throughout the entire three-dimensional array. These array scans are applied in repetition until the values stabilize (mathematically converge) for the given boundary conditions.

In an exemplary embodiment, the CFD calculations may require the use of 32-bit floating-point representations of numbers in an IEEE-754 standard format throughout the calculation. 32-bit floating-point operations are preferred over larger formats, such as 64-bit, because they are more viable with available field programmable gate-array (FPGA) device technologies, and thus, are viable for Reconfigurable Computing (RCC) hardware. One reason for this is because 64-bit floating-point operations require two to four times as many digital logic resources, such as additional hardware multipliers, external memory, memory bandwidth, etc. while FPGA devices have only a finite amount of these resources. However, it will be appreciated by persons skilled in the art that, apart from requiring physically larger FPGA parts, moving from a 32-bit to 64-bit floating point format (or even to another format such as fixed-point) will not materially affect the implementation of CFD algorithms on reconfigurable computing platforms.

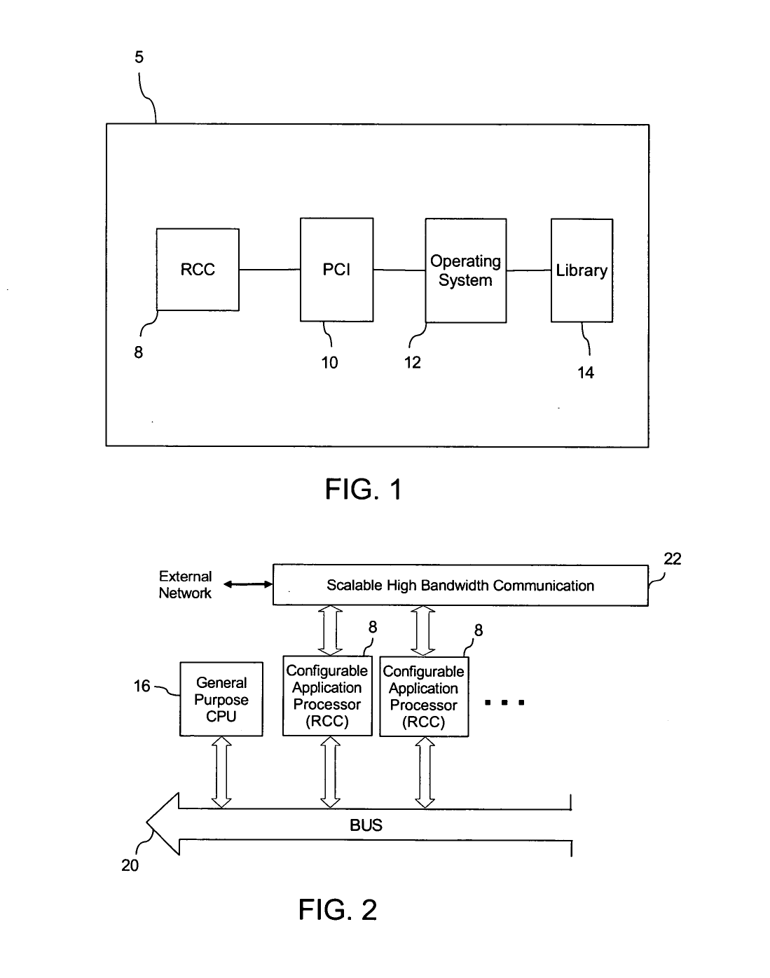

FIG. 1 is an exemplary embodiment of a CFD accelerator 5 embodying aspects of the invention. As illustrated, the accelerator 5 comprises RCC hardware 8 coupled with Peripheral Component Interface (PCI) based communications and control element 10. A host operating system 12 with application programming interfaces (APIs) for communication, configuration and control of the RCC hardware, and a floating-point math library 14, such as an IEEE 754-compliant 32-bit floating-point library.

As further illustrated in FIG. 2, a representative CFD processing node uses conventional x86-type processors as the host system CPU 16, or processor, that is coupled with reconfigurable hardware 8. The conventional x86-type processor 16 is acting as a communications manager and host for the implementation of aspects of the invention on reconfigurable hardware, and is not necessarily involved in the actual CFD computation in the traditional sense as discussed above. In an exemplary embodiment, the CPU 16 and reconfigurable hardware 8 are coupled via a 64-bit PCI bus 20. One skilled in the art will recognize that the bus 20 can be of other sizes such as, but not limited to, a 32-bit PCI bus, or can be of different types, such as high-speed Ethernet.

The host system CPU 16 uses an operating system 12, illustrated in FIG. 1, such as either Linux or Windows, wherein the accelerator 5 is operable under the operating system 12. The Peripheral Component Interface (PCI) bus 20 configures and controls the RCC hardware 8 as well as manages the data communications with the accelerator 5.

Even though the PCI bus 20 configures and controls the data communications, communications with the CFD algorithms take place among the RCC hardware 8 elements directly via a scalable high bandwidth (for example in excess of one gigabit per second and higher) communication element 22, and bypass the PCI bus 20. By doing so, a communication bottleneck at the PCI bus 20 is averted.

Presently, the fastest known PCI-style bus runs at approximately 133 MHz. Memory within a personal computer runs at approximately 400 MHz. Thus, by allowing communications to take place among the RCC hardware 8, elements outside the confines of the limited speed available through the PCI bus 20 instead communicate through the memory of the personal computer. Communication through the memory can be accomplished using any one of a plurality of known competing standards, such as, but not limited to, low-voltage differential signaling (LVDS), hypertransport, and Rocket Input/Output (I/O). These techniques can result in communications occurring on an order of one gigabit per second and higher.

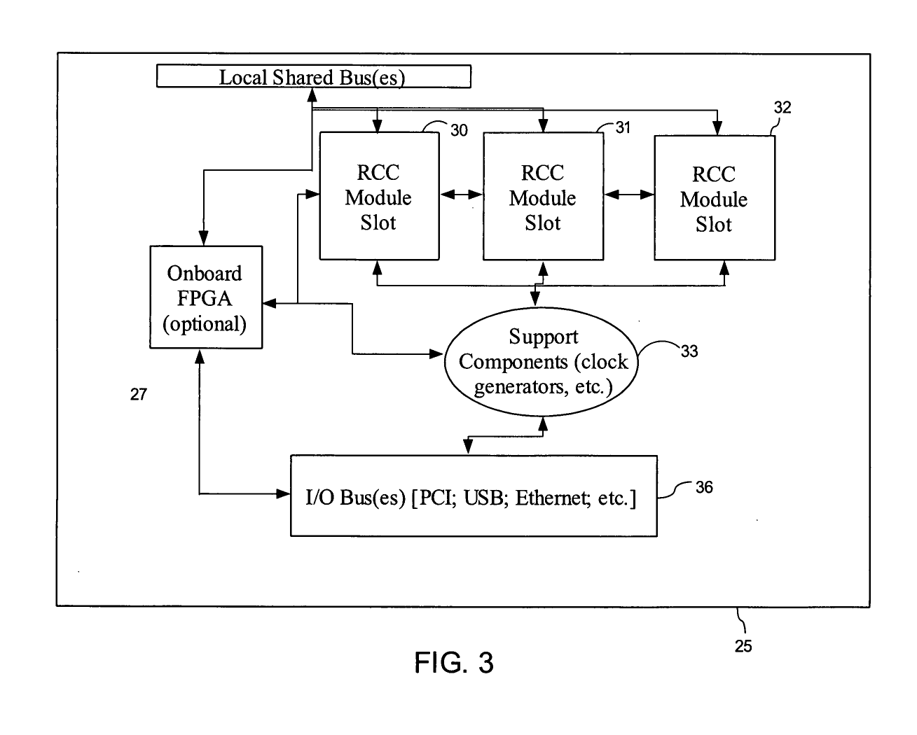

FIG. 3 is an exemplary embodiment of a carrier card. In an exemplary embodiment, a 64-bit PCI carrier card 25 is used as the PCI-based carrier card for the RCC hardware components 8. The PCI carrier card 25 has components for communication support 33, programmable FPGA device 27, module sites 30, 31, 32 for adding a variety of FPGA-based modules and an input/output bus 36. PCI carrier cards are commercially available, such as from Nallatech or SBS Technologies.

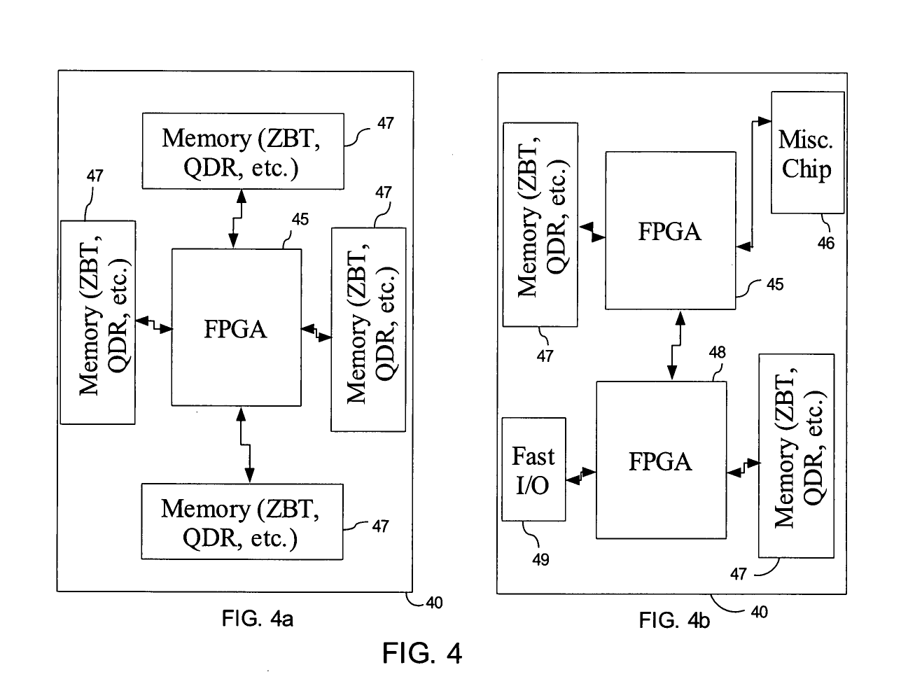

Though other variations are possible, in an exemplary embodiment, each FPGA device would be connected to a module 40. Each FPGA device 45 is then connected to a memory device 47, such as a ZBT SRAM memory device, as illustrated in FIG. 4a. As further illustrated in FIG. 4a, the memory device 47 is not limited to being a ZBT memory device. Each FPGA device 45 may implement such exemplary operations as algorithm-specific calculations pipelines (pipelined 32-bit floating-point data paths corresponding to the inner-loop calculations within the CFD algorithms); address generation and control logic, array data caches in buffer random access memory (BRAM); external memory controllers for streaming data to and/or from the calculation pipelines; and additional routing logic for application data communications with the host CPUs as well as with other FPGA devices.

As illustrated in FIG. 4b, two FPGA devices 45, 48 may be connected in series where a second chip 46, is connected to one FPGA device 45 while an input/output device 49 is connected to the second chip. Both FPGA devices 45, 48 have memory devices 47 connected to them. Those skilled in the art will readily recognize that other exemplary embodiments are possible where more than one FPGA device is utilized.

High-level algorithms are partitioned to fit onto the modules 40 with three-dimensional arrays assigned to the memory devices 47. Each card 25 also has external input/output connections 36 for high-speed communications with other modules within the same system chassis, or, between different carrier cards 25.

The host system operating system 12 is responsible for configuring the FPGA module 40 used in the RCC hardware 8. The operating system 12 also manages data transfers to and from the RCC hardware 8 and coordinates the communication and control of the accelerator 5. The CFD accelerator 5 executes inner loop calculations using associated iteration control logic on the RCC hardware 8. In general, just the inner-loop calculations and associated iteration control logic are executed on the RCC hardware 8.

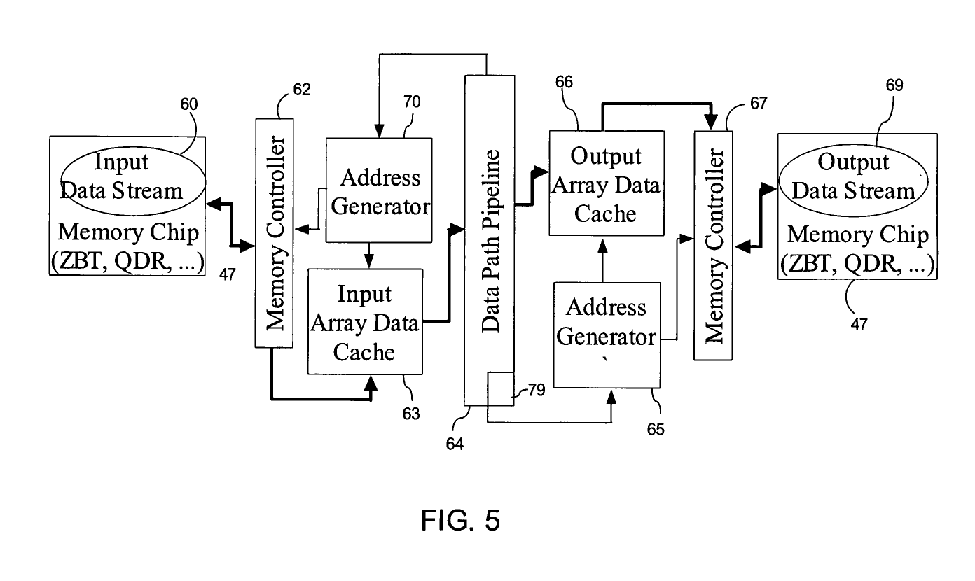

FIG. 5 is an exemplary embodiment of functional components in the RCC hardware. These components may be tailored to meet various characteristics such as, but not limited to, array stencil geometries and arithmetic computations of the corresponding part of the algorithm. As illustrated, an input data stream 60, is supplied from a memory device 11 to a memory controller 62. The memory controller 62 feeds the data stream 60 to an input array data cache 63. Once there, the data stream 60 is fed into a data path pipeline 64. A signal is fed from the data path pipeline 64 to a first address generator 65 that sends an address signal to the memory controller 62 and the input array data cache 63. A signal is also fed from the data path pipeline 64 to a second address generator 65. The second address generator 65 sends the second address signal to an output array data cache 66. The data stream 60 at the data path pipeline 64 is also supplied to the output array data cache 66. The data stream 60 is then fed to a memory controller 67 that also receives the second address signal from the second address generator 65. The data stream 60 is then fed from the memory controller 67 as an output data stream 69 to a memory device 68.

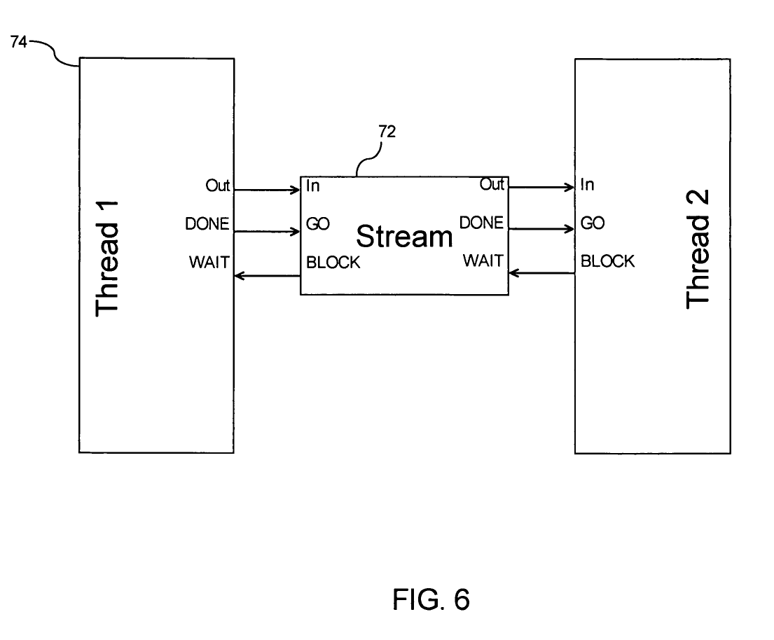

The architecture for the control-flow synchronization of the elements illustrated in FIG. 5 is based on a collection of asynchronous execution threads that communicate via streams or hardware with first in/first out (FIFO) characteristics, as illustrated in FIG. 6. A stream 72 has finite storage capability and is functional to block a writing thread 74, if there is no room available for additional data. If the stream 72 has room for new data, the writing thread 74 will resume execution. This stream communication approach can be applied for communications within a single FPGA device, as well as for communications between two different FPGA devices, when using the carrier card's communication links as shown in FIG. 3.

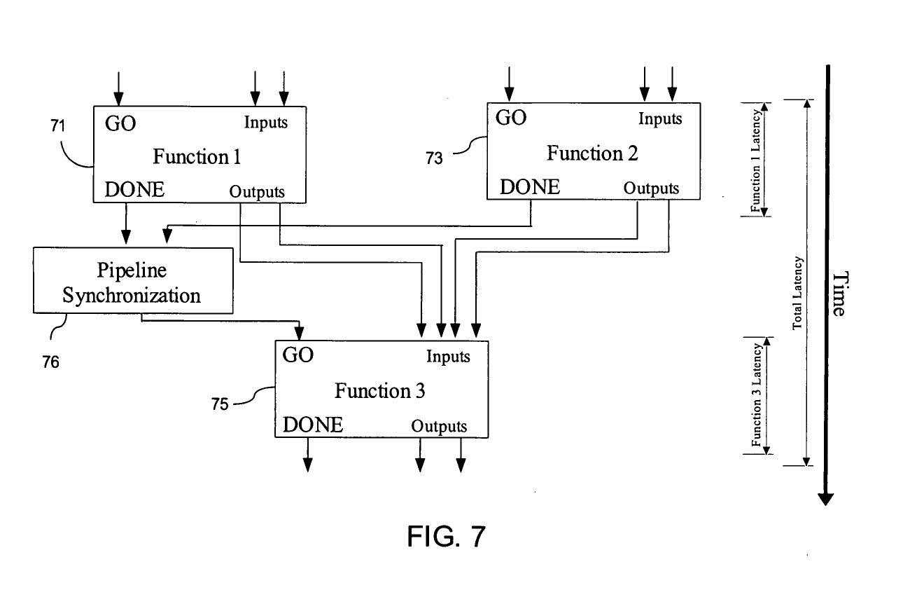

The data flow and control flow dependencies within a hardware function or component are implemented using a GO-DONE technique, which provides synchronization of operators within a given control flow, as exemplarily illustrated in FIG. 7. More specifically, a GO-DONE technique is used for computer components to communicate between each other, where a first component sends data to a second component, and the second component responds with data either back to the first component or to an optional third component. The first component prepares data for transmission and then notifies the second component that data is available by transmitting a “GO” signal. The second component, in turn, reads the data transmitted by the first component, performs some computation and when complete, prepares the result data for transmission and then transmits a “DONE” signal to the first component, or if present the optional third component. Beyond being an implementation technique, use of this technique facilitates functional simulation and debugging of a design.

As illustrated a “GO” signal and input data is supplied to a first Functions 1 71 and second Function 73. Data from each function 71, 73 is supplied to a third Function 75. When the first and second Functions are complete, “DONE” signals are transmitted from the functions 71, 73, through a Pipeline Synchronization device 76 to the third Function 75.

The memory controllers 62, 67, illustrated in FIG. 5, are responsible for streaming data to and from the external memory devices 47. The memory controllers 62, 67 are capable of handling data transfers from the host CPU 16 as well as streaming array data to and/or from the array caches used in CFD computations. In an exemplary embodiment, memory devices 47 allow data reads and writes to be fully intermixed with no wait states required between such operations. The memory operations have fixed latency characteristics, which result in deterministic (i.e. non-random and predictable) scheduling for the hardware interactions with the internal memory.

The data path pipelines 64, illustrated in FIG. 5, or calculation pipelines, are derived from the inner-loop calculations in the CFD application code. The address generators 65, 70 and array data caches 63, 66 for the source arrays, handle the array references, and the corresponding values are streamed through the calculation pipeline 64. Each floating point operation in the calculation maps to a floating-point operation instance in the hardware. Since the operators have different latencies, delay logic 79 is introduced to synchronize the flow of data through the pipeline 64. The corresponding address generator 65 and array cache 66 for the computed array collects the resulting values. Though the transformation steps for mapping the inner loop code to the corresponding calculation pipelines 64 and address generator/array cache implementation are preferably done automatically by a high-order language compiler, it is possible to complete the transformations manually.

The address generators 65, 70 are responsible for managing the streaming of data to and from external memory and the array data cache 63, 66. The address generators 65, 70 implement loop iteration parameters that are used in sweeping the stencil through the three-dimensional array. In an exemplary embodiment, the stencil geometry characteristics also define the behavior of the address generators 65, 70 and the implementation details of the array data cache architecture 63, 66. Using a strip mining approach to cache management, only a single memory read per result computation, regardless of stencil geometry, is realized.

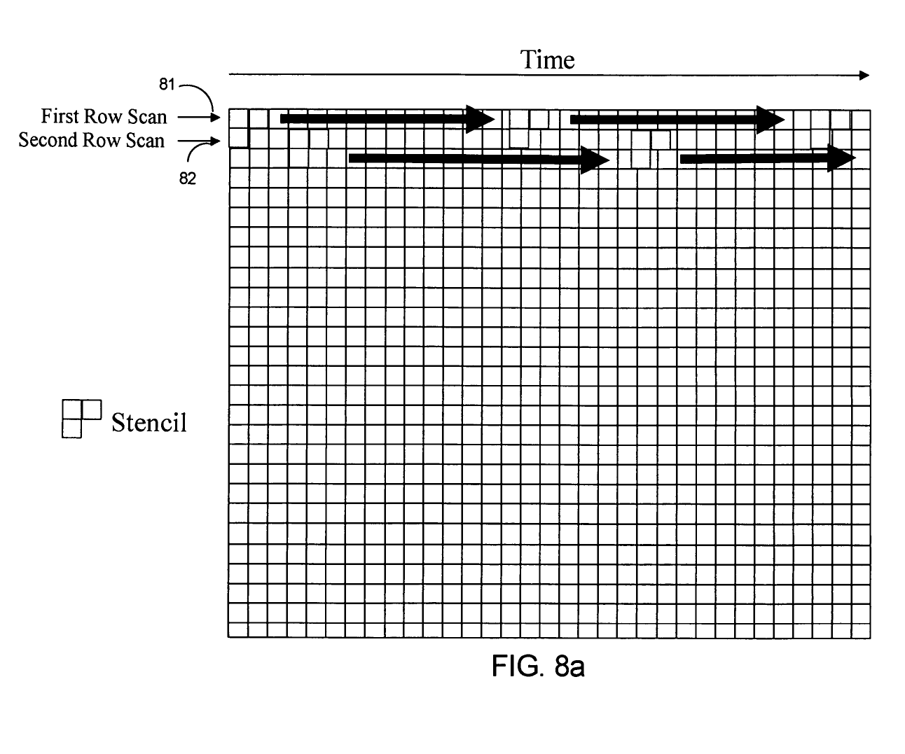

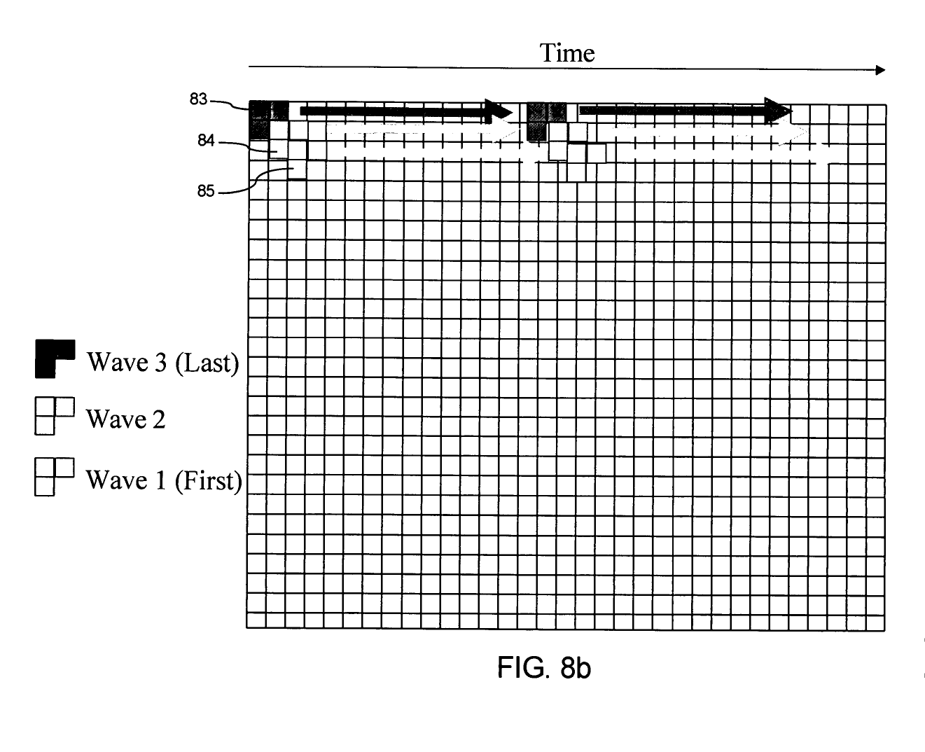

In certain circumstances, it may be possible to further boost the computation rates of the RCC hardware by using multiple processing waves, wherein multiple stencil scans 81, 82 are performed during a single array scan, as illustrated in FIG. 8a. Applying this technique is beneficial when there are sufficient FPGA devices 45 available to implement more than one instance of the calculation pipeline hardware and data array caches, or where there is sufficient slack in the clock rate for the calculation pipeline 64 to support multi-phase clocking of the hardware. This approach is further illustrated in FIG. 8b, wherein a first wave 83, second wave 84, and third wave 85 scan is employed.

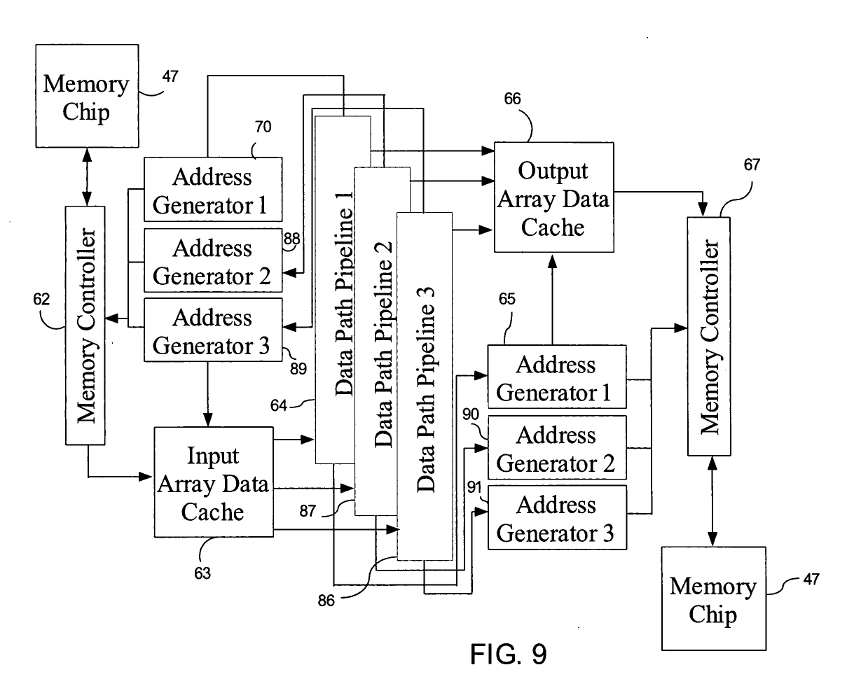

FIG. 9 illustrates when a plurality of scans or waves are used. A first Memory chip 47 send and receive a data stream 60 from a first memory controller 62. The first memory controller 62 sends the data stream 60 to an input array data cache 63. The data cache 63 sends the data stream 60, as illustrated in FIG. 8b, to a plurality of data path pipelines 64, 85, 86. The plurality of data path pipelines 64, 85, 86 send signals to a first set of address generators 70, 88, 89 associated with each respective data path pipeline 64, 85, 86. The first set of address generators 70, 88, 89 sends an address signal to the first memory controller 62 and to the first input array data cache 63. The plurality of data path pipelines 64, 85, 86 also transmits the data to a second input array data cache 66 as well as information to respective second set of address generators 65, 90, 91. The second set of address generators 65, 90, 91 sends respective address signals to the second array data cache 66 as well as to a second memory controller 67. The second input array data cache 66 also sends data to the second memory controller 67. The second memory controller 67 sends and receives data from a second memory chip 47.

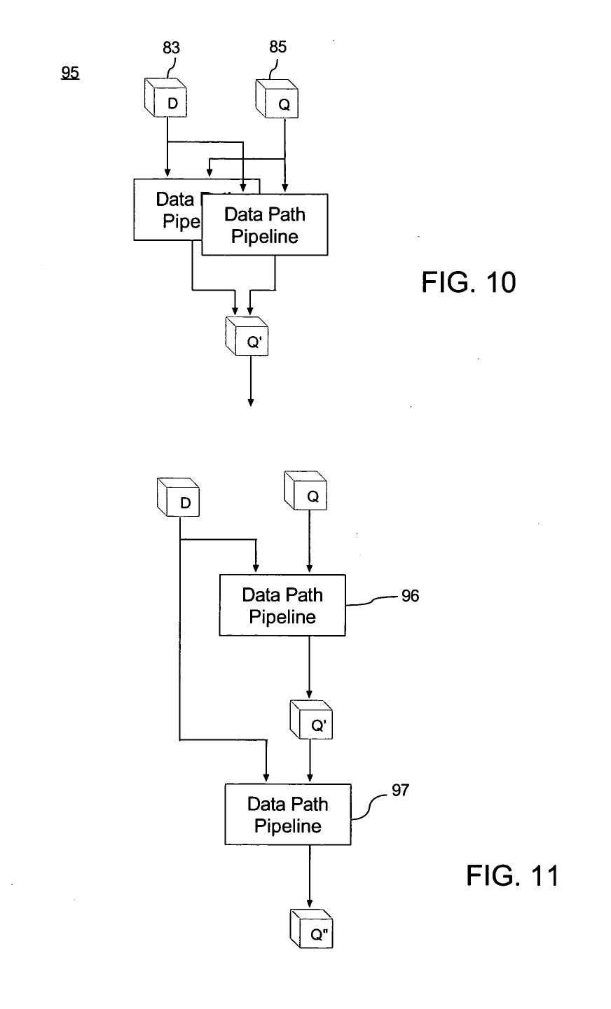

As illustrated, the multiple processing techniques may either use a concurrent technique, where more than one wave 83, 84, 85 is used in a single CFD time step 95, as illustrated in FIG. 10, or concurrent waves are used, which compute results for successive time steps 96, 96, as illustrated in FIG. 11. Concurrent waves, illustrated in FIG. 10, are preferred when the memory clock rate and the associated data rates are greater than the calculation pipeline clock rate. The cascade waves, illustrated in FIG. 11, are preferred when the calculation pipeline and memory data rates are equally matched.

While the invention has been described in what is presently considered to be an exemplary embodiment, many variations and modifications will become apparent to those skilled in the art. Accordingly, it is intended that the invention not be limited to the specific illustrative embodiment, but be interpreted within the full spirit and scope of the appended claims.

1. A system for accelerating computational fluid dynamics calculations with a computer, said system comprising:
a. a plurality of reconfigurable hardware components;
b. a computer operating system with an application programming interface to connect to said reconfigurable hardware components;
c. a peripheral component interface unit connected to said reconfigurable hardware components for configuring and controlling said reconfigurable hardware components and managing communications between each of said plurality of reconfigurable hardware components to bypass said peripheral component interface unit and provide direct communication between each of said plurality of configurable hardware components.

2. The system of claim 1 further comprising a floating-point library connected to said plurality of reconfigurable hardware components.

3. The system of claim 1 wherein each of said plurality of reconfigurable hardware components comprises a field-programmable gate array module and a memory device.

4. The system of claim 3 herein said memory device comprises at least one of a zero bus turnaround static random access memory module, double date rate synchronous dynamic random access memory module, analog to digital converter, and a digital to analog converter.

5. The system of claim 1 wherein said computer operating system configures each of said plurality of reconfigurable hardware components, manages data transfers to and from each of said plurality of reconfigurable hardware components, and coordinates communication and control of said acceleration system.

6. The system of claim 1 wherein each computational fluid dynamic calculation is performed by said plurality of reconfigurable hardware components.

7. A reconfigurable hardware component for performing computational fluid dynamics algorithms that is operable to communicate directly between other reconfigurable hardware components, said component comprising:
a. a first data stream;
b. a first memory controller that at least one of sends and receives a first data stream;
c. a first data cache connected to said first memory controller to receive said first data stream;
d. a data path pipeline connected to said first data cache to perform calculations resulting in a modified first data stream;
e. a second data cache connected to said data path pipeline to receive said modified first data stream; and
f. a second memory controller connected to said second data cache to at least one of send and receive said modified first data stream.

8. The component of claim 7 further comprising a first address generator to receive signals from said data path pipeline based on said data stream and said modified data stream and transmit signals to said first memory controller and said first array data cache.

9. The component of claim 7 further comprising a second address generator to receive signals said data path pipeline based on said modified data steam and transmit signals to said second memory controller and said second array data cache.

10. The system of claim 7 further comprising a first memory device to at least one of send and receive said data stream supplied to said first memory controller and a second memory device to at least one of send and receive said modified data stream.

11. The system of claim 10 wherein said first memory device and said second memory device are a single memory device.

12. The system of claim 10 wherein said memory devices allow data reads and data writes to be intermixed with no wait states.

13. The system of claim 10 wherein each of said memory devices is at least one of a zero bus turnaround static random access memory module, double date rate synchronous dynamic random access memory module, analog to digital converter, and a digital to analog converter.

14. The system of claim 10 wherein each of said memory devices further comprise fixed latency characteristics that result in deterministic scheduling for interactions each of said memory devices.

15. The system of claim 7 further comprising a computational fluid dynamics algorithm wherein hardware that comprises said data path pipeline is coded with information to correspond with operators in said algorithm.

16. The system of claim 7 wherein a plurality of scans is performed simultaneously within said data path pipeline.

17. The system of claim 16 further comprising a plurality of said data pipelines, a plurality of said first address generators, and a plurality said second generators that individually correspond to one of said plurality of scans being performed.

18. The system of claim 17 wherein multiple waves are taken during a single computational fluid dynamics computational time step.

19. The system of claim 18 wherein wave results are computed for successive time steps.

20. A method for accelerating computational fluid dynamics algorithms with a plurality of reconfigurable hardware components that is operable to allow each reconfigurable hardware component to communicate directly between other reconfigurable hardware components, said method comprising:
a. within a first reconfigurable hardware component, transmitting data from a first memory device;
b. managing said transmitting of said data with an address generator;
c. performing calculations on said data;
d. transmitting resulting data generated to a first array cache;
e. transmitting said resulting data from said first data cache to a second memory device; and
f. transmitting said resulting data from said first reconfigurable hardware component to a second reconfigurable hardware component.

21. The method of claim 20 further comprising transmitting said data to and from said first memory device through a first memory controller.

22. The method of claim 20 further comprising transmitting said data through a second data cache prior to said step of performing calculations.

23. The method of claim 20 further comprising transmitting said resulting data from said first data cache to a second memory controller and then to said second memory device.

24. The method of claim 20 further comprising managing said transmitting of said resulting data with a second address generator.
